(19) United States
(12) Patent Application Publication
(10) Pub. No.: US 2005/0015455 A1
(43) Pub. Date: Jan. 20, 2005

(54) SPAM processing system and methods including shared information among plural SPAM filters

(76) Inventor: Gary G. Liu, Plano, TX (US)

Correspondence Address: FISH & RICHARDSON P.C., 3300 DAIN RAUSCHER PLAZA, MINNEAPOLIS, MN, 55402, US

(21) Appl. No.: 10/623,112

(22) Filed: Jul. 18, 2003

(51) Int. Cl. G06F 15/16; H04L 9/32; H04L 9/00; G06F 12/14; G06F 11/30

(52) U.S. Cl. 709/207; 709/204; 713/200

(57) ABSTRACT

Methods and apparatus for filtering spam. In one aspect, the method is for filtering spam in a messaging system and includes confirming that a message sender can receive, sharing information indicating that the message sender can receive among a plurality of spam filters in the messaging system and using the information at a given one of the plurality of spam filters to determine if a message should be allowed without separately determining whether the message sender can receive.

### TECHNICAL FIELD

This invention relates to methods and apparatus for processing messages.

### BACKGROUND

With the advent of modern computer technology, individuals increasingly use electronic means to transfer information from one location to another. For example, E-mail is a popular and efficient means for transferring information from one user to another. The popularity of messaging systems such as E-mail has risen dramatically among individuals, and a similar rise has occurred in the business use of messaging systems. Conventional point to point transfers from one computer to another represent the vast majority of these communications, however a myriad of handheld devices are now available that deliver messages to non-traditional computing platforms (pagers, PDA's, Blackberry devices, Internet set top boxes and the like).

Unfortunately the use of such messaging systems comes with measures of difficulties. The messaging systems have become a equally convenient form of communication for marketers, promoters, advertisers and others wishing to provide often unsolicited content (spam) to users of such messaging systems. Studies have suggested that spam accounts for nearly ⅓ of all the message traffic coming into a corporate messaging system. Further, malicious use of spam can create system failures, such as seen when a denial of service attack is successful in overloading a target messaging system. In addition to individual inconveniences, spam adds to network congestion (e.g., Internet congestion) by consuming large amounts of storage space and bandwidth. While the cost of sending out millions of spam emails is very low (much cheaper than postal junk mail), the costs (direct and indirect) on the receive end is not insubstantial.

Numerous conventional systems exist for identifying and processing spam. Some conventional systems rely on identifying the source of the spam, e.g., the real email address of the spam sender. However, “spammers” (i.e., spam originators) often mask their identity or source of origin to avoid these type of detection systems. In one type of conventional system employed at an Internet Service Provider (ISP), the identification of a source (i.e., real email addresses of a spammer) will cause the ISP to immediately terminate the spammer's account or limit their activity.

Since most spammers do not identify themselves (e.g.; their real source email addresses) this information can be used to filter out a significant amount of spam. For example, a conventional spam filter can be used to send back a confirmation E-mail to a source E-mail address of a suspect message to check if the sender can receive. If the confirmation fails, this information can then be used to decide whether a message should be treated as a spam. Such an idea has been used in several anti-spam systems, including the systems and methods disclosed in U.S. Pat. Nos. 6,199,102 and 6,546,416, and the published patent application 20030009698.

In all these systems, a spam filter installed either at an E-mail client or at a mail server is used to filter out spam. When an E-mail message arrives at the spam filter, the spam filter will temporarily hold the message and send a confirmation E-mail to the original sender. The message held will be delivered only after the original sender answers the confirmation E-mail correctly. Optionally, the spam filter keeps a list of confirmed senders (a “white list”). When a sender answers the confirmation email correctly, he will be put into the white list so that the next time when a message from the same sender arrives, the message will be delivered without delay and without sending another confirmation E-mail.

One problem of these prior art systems, however, is that they generally require a conventional sender (i.e., non-spammer) to answer many confirmation emails, causing quite an inconvenience to the sender. For a system that does not use a white list, a conventional E-mail sender generally needs to answer as many confirmation E-mails as the number of spam filters installed among the recipients for each E-mail message the sender sends out. For example, if one sends an E-mail to three recipients (john@example.com, gary@anotherexample.com, and cc's dave@thirdexample.com), the sender would be required to answer three confirmation E-mails, if all the recipients have an anti-spam filter installed. In addition, the conventional sender would have to answer three confirmation emails each time a message is sent to the three recipients.

For a system that uses a white list, a conventional E-mail sender generally needs to answer as many confirmation E-mails as the number of spam filters installed among the recipients for at least a first message sent. Because each spam filter keeps a separate white list, a conventional sender still needs to answer one confirmation E-mail for each spam filter installed among the recipients he sends E-mails to. In the above example, the conventional sender still has to answer three confirmation E-mails when he sends out a first message, although he/she will not receive any confirmation E-mails when he sends additional messages to the same three recipients.

One shortcoming of these prior art systems is that each conventional spam filter works in isolation and does not share information with other spam filters. More specifically, conventional spam filters do not share a white list of verified sender addresses. For this reason, a conventional spam filter always has to send a confirmation email to each sender to verify his E-mail address, even though other spam filters within a given network may have already verified his E-mail address. In addition, conventional spam filters do not share other information that could be useful in detecting spammers, such as information to detect a spammer's signature. For example, because a spammer sends to a large number of unrelated E-mail addresses, events detected by a plurality of spam filters could be correlated and trends developed to detect a signature of a spammer (e.g., this address, though valid, sends too many messages to unrelated E-mail addresses), even if that spammer is using his/her real E-mail address. Conventional spam filters in these prior art systems work in isolation, and do not share information that could be correlated to detect the signature of spammers.

### SUMMARY

In one implementation, the invention provides a data center to send out confirmation messages (e.g., E-mails), to process sender's responses, and to keep a “white list” of confirmed senders, a “black list” of known spammers, and an “unconfirmed list” of the senders who have not answered a confirmation yet. In this implementation, the spam filters, on the other hand, do not handle confirmation messages or keep any of the lists. A spam filter queries the data center to obtain the status of a sender in order to determine whether a received message from that sender should be delivered, disposed (e.g. deleted, sent to a junk mail boxes, etc.), or temporarily held while the data center is waiting for the answer to the confirmation message.

In another implementation, the invention provides a method for detecting spam in a messaging system and includes generating a white list of confirmed message senders, each of said confirmed message senders having been confirmed as being able to receive messages. The method includes sharing the white list among a plurality of spam filters in the messaging system and using the white list at a given one of the plurality of spam filters to determine if a sender of a received message has been previously confirmed. If the sender has been confirmed, the method includes forwarding the received message to a recipient without separately confirming the sender.

Aspects of the invention can include one or more of the following features. The messaging system can be an email system. The white list can be shared with at least two spam filters. If the sender has not been previously confirmed, the method can include sending a confirmation to the sender and verifying a response from the sender. If the response is verified, the sender can be added to the white list at the given spam filter and the information can be shared with other spam filters in the messaging system. Sharing can include publishing the white list at a central location. Using the white list can include checking the white list maintained at a central location. If the sender has not been previously confirmed, the method further includes sending a confirmation to the sender and verifying a response from the sender. If the response is verified, the method can include adding the sender to the white list at a central location that is shared among the plurality of spam filters.

In another aspect, the invention provides a method for identifying a spam message and includes receiving a message at a spam filter in a network that includes a plurality of spam filters, identifying the sender of the message and determining if the sender has been previously confirmed as a valid sender including determining if the sender is included in a list of confirmed senders for any spam filter in the network. If the sender has been confirmed, then the method can include forwarding the received message to a recipient without separately confirming the sender.

Aspects of the invention can include one or more of the following features. The method can include determining if the sender has not been previously confirmed and if not confirmed, sending a confirmation to the sender and verifying a response from the sender. If the response is acceptable, the sender can be added to the white list at the given spam filter and the information can be shared with other spam filters in network. Sharing can include publishing the white list at a central location.

In another aspect, the invention can provide a method for detecting a spammer in a network that includes a plurality of spam filters and includes collecting information relating to a sender from a plurality of the spam filters, determining a trend in the collected information and identify a spammer based on the trend.

Aspects of the invention can include one or more of the following features. Collecting information can include collecting information relating to a number of messages sent by a sender to unrelated email addresses. Determining trends can include correlating the messages received by an individual spam filter relating to a same sender. Identifying can include determining that a sender is a spammer if a number of messages sent to unrelated email addresses in the correlated data exceeds a predetermined threshold. The threshold can be time dependent.

In another aspect the invention provides a method for detecting spam in a messaging system and includes generating a white list of confirmed message senders and maintaining the white list at a data center, receiving a message at a spam filter in a network that includes a plurality of spam filters, verifying with the data center that the sender of the message is a confirmed message sender, add if so, forwarding the received message to a recipient without separately confirming the sender.

In another aspect the invention provides a method for identifying a spam message and includes receiving a message at a spam filter in a network that includes a plurality of spam filters, identifying the sender of the message and verifying with a data center coupled to a plurality of the spam filters if the sender has been previously confirmed as a valid sender including determining if the sender is included in a list of confirmed senders for any spam filter in the network, the list being maintained at the data center. If the sender has been previously confirmed, the received message is forwarded to a recipient without separately confirming the sender.

In another aspect, the invention provides a method for detecting a spammer in a network that includes a plurality of spam filters and includes collecting, using a data center, information relating to a sender from a plurality of the spam filters, determining a trend in the collected information; and identifying a spammer based on the trend, including adding the sender to a list of confirmed spammers maintained by the data center.

Aspects of the invention may include one or more of the following features. Collecting information can include collecting information relating to a number of messages sent by a sender to unrelated email addresses. Determining trends can include correlating messages received by an individual spam filter relating to a same sender. Identifying can include determining that a sender is a spammer if a number of messages sent to unrelated email addresses in the correlated data exceeds a predetermined threshold.

In another aspect, the invention provides a method for filtering spam in a messaging system and includes confirming that a message sender can receive, sharing information indicating that the message sender can receive among a plurality of spam filters in the messaging system and using said information at a given one of the plurality of spam filters to determine if a message should be allowed without separately determining whether the message sender can receive.

Aspects of the invention can include one or more of the following features. A passcode can be associated with one or more of the confirmed senders in the list, and the method can include verifying a message received from a sender in the list includes the passcode if specified. The method can include triggering an addition of a passcode for a sender in the list upon an occurrence of an predefined event. The event can include detection that an email address associated with the sender has been compromised. A pass code can be included in the list for one or more confirmed senders. The passcode can be automatically added at a time for transmission of a message from the sender in the messaging system. A plug in module can be provided for automatically adding the passcode. The plug in module can be adapted to add the passcode prior to transmission to the messaging system. The method can include correlating sender-recipient data at a spam filter in the messaging system, determining data related to how fast a list of recipients grows for a given sender; determining a list of unacceptable senders using the sender-recipient data and the determined data and sharing the list of unacceptable senders with other spam filters in the messaging system. The method can maintain a list of recipients for each sender of messages processed by a given spam filter. The list can be maintained at a data center.

In one aspect, the invention provides a method for processing messages at a spam filter in a messaging system where the messaging system includes a plurality of spam filters. The method includes receiving a message for processing, the message from an sender for delivery to an intended recipient, and determining if the sender is a confirmed sender including querying a data center to determine if the sender is included in a list of confirmed senders based on information received from any of the plurality of spam filters in the messaging system. Confirmed senders are senders having a verified capability to receive messages. If the sender is a confirmed sender, the method can enable transmission of the message to the intended recipient.

In another aspect, the invention provides a method for processing messages at a spam filter in a messaging system, the messaging system including a plurality of spam filters. The method includes receiving a message for processing, the message from a sender for delivery to an intended recipient, determining if the sender is a confirmed sender, including querying a data center to determine if the sender is included in a list of confirmed senders based on information received from any of the plurality of spam filters in the messaging system. Confirmed senders are senders having a verified capability to receive messages. If the sender is a not a confirmed sender, the sender is confirmed including sending the sender a notification. Upon receipt of a confirmation from the sender, the sender's confirmed status can be shared with the plurality of spam filters in the messaging system including publishing the sender's status to the data center.

In another aspect, the invention provides a method for minimizing spam in a messaging system, the messaging system including a plurality of spam filters. The method includes receiving a request from one of the spam filters in the messaging system to verify if a sender of a message is a confirmed sender. A confirmed sender is a sender having a verified capability to receive messages. The method includes evaluating a list of confirmed senders and providing a notification to the one spam filter indicating whether the sender's status is confirmed.

In another aspect, the invention provides a method for minimizing span in a messaging system and includes receiving a request from one of the spam filters in the messaging system to verify if a sender of a message is a confirmed sender, a confirmed sender being a sender having a verified capability to receive messages and evaluating a list of confirmed senders. If the sender is not included in the list of confirmed senders, the method includes confirming the sender including providing a notification to the sender and upon receipt of a confirmation of from the sender, sharing the sender's status with the other spam filters in the messaging system including adding the sender to the list and providing a notification to the one spam filter indicating whether the sender's status is confirmed.

The invention can be implemented to realize one or more of the following advantages. A system is provide that eliminates the inconvenience of having to answer many confirmation emails, and allows for information to be collected and shared by all the spam filters in a given network. A system and method are provided for sharing white lists among spam filters in a given network. In addition, a system and method is provided for collecting information from among plural span filters and correlating information to detect the signature of a spammer, even if the spammer may be using his/her real email address. Using the proposed system, a conventional E-mail sender only needs to answer one confirmation email, regardless of the number of spam filters that are installed by the intended recipients of his messages. Using the proposed system, information can be collected by the data center from the spam filters and analyzed to detect spammers, even if these spammers use their real email address and are able to answer confirmation emails. In the proposed system, the spam filters are much simplified because they do not have to handle confirmation emails and manage the lists (white list, the black list, and the unconfirmed list)

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a simplified block diagram of an anti-SPAM system including a Data Center and three different SPAM Filter configurations.

FIG. 2 is the logical flow of SPAM Filter Logic.

FIG. 3 is the logical flow of the Held Message Handler FIG. 4 is the data format of the requests sent from the SPAM filter and the responses from the Data Center.

FIG. 5 is the logical flow of Check Sender Status Service for the Data Center.

FIG. 6 is the logical flow of Update Status Service for the Data Center FIG. 7 is an example of confirmation email sent to the Sender.

FIG. 8 is the logical flow of Sender Response Processor for the Data Center.

FIG. 9 contains examples of email notices sent to a Sender when the pass code requirement is turned on or off.

Like reference symbols in the various drawings indicate like elements.

### DETAILED DESCRIPTION

The present invention provides a unique method for identifying and processing unwanted message content in a messaging system. It is understood that the following disclosure provides many different implementations, or examples, for implementing different features. Techniques and requirements that are only specific to certain implementations should not be imported into other implementations. Also, specific examples of networks, components, and formats are described below to simplify the present disclosure. These are, of course, merely examples and are not intended to limit the invention from that described in the claims. While an email messaging system will be described, the teachings of the present invention may have applicability to other messaging systems.

In the implementation described below, a Data Center is used to send out confirmation emails to email senders to confirm that they can receive. Normal email senders have no problem receiving the confirmation email and responding to it. Spammers, however, afraid of being tracked down quickly, rarely use real email addresses when sending out spam, and therefore cannot receive the confirmation email and respond to it. Once a sender has successfully responded to the confirmation email, the sender will be put into a list of confirmed senders (a “white list”) maintained in the Data Center. In one implementation, a “black list” of known spammers can also be kept by the Data Center. A plurality of SPAM Filters can be installed either at mail servers or at email clients throughout a given network. The SPAM Filters can query the Data Center to obtain the sender's status information to decide whether an email message from that sender should be delivered, disposed, or temporarily held. In one implementation, if the sender is in the “black list”, the message will be disposed; and if the sender is in the “white list”, the message will be delivered (with exceptions which will be discussed below). If the sender is neither in the “white list” nor in the “black list”, the Data Center will send a confirmation email to the sender, and then return certain information such as how many confirmation emails have been sent to that email sender and how long the Data Center has been waiting for the answer. Such information can then be used by the SPAM Filter to decide whether to deliver the message, dispose the message, or temporarily hold the message according to a local policy that is specific to the individual SPAM Filter. For the messages temporarily held, the SPAM Filter can check with the Data Center periodically to see if the sender's status has changed and then decide whether the message should be delivered, disposed, or continue to be held according to the local policy.

It is possible that a spammer may send out spams pretending to be from a legitimate user already in the white list. In order to block spammer's messages while allowing the legitimate user's messages to go through, a “pass code” may be required for certain email addresses in the white list. The pass code can be maintained in the Data Center. If the pass code requirement is turned on for an email address in the white list, the returned sender status from the Data Center will indicate that the sender is in the white list, but a specific pass code is required. The SPAM filter can be configured to block the message unless it contains the correct pass code (on the first line or in the header, for example). The pass code can be sent by the Data Center to the email address owner in an email. The spammer that does not actually own that email address will not be able to receive/know the pass code. The burden for the legitimate user to add the pass code to every message can be eliminated by an email client plug-in that automatically inserts the pass code into sent messages. The pass code requirement can be enabled or disabled as required if the system of the user determines that spam is being “sent” from a given users account.

When a large number of SPAM Filters are installed at many sites over the Internet, the Data Center will be able to collect rich information from the queries sent by the SPAM Filters. Such information can be used to distinguish spammers from certain legitimate bulk email senders, such as a subscription-based mailing list. One such example of information collected is sender-recipient correlation data. By keeping a list of recipients that a sender has ever sent a message to, the Data Center can detect spam events by watching how fast the recipient list grows. For a spammer, the list of recipients will grow very fast while each batch of spams is usually sent to a different set of recipients. For a mailing list sender, the list of recipients will grow slowly and different messages will be sent to roughly the same set of recipients periodically. These different signatures can be used to distinguish spammers from mailing lists.

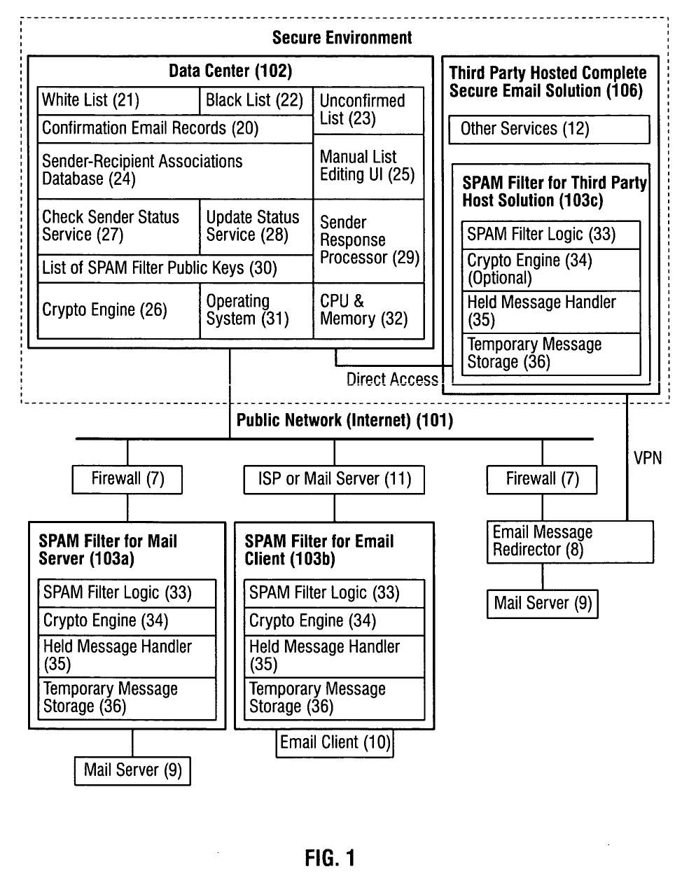

As shown in FIG. 1, a Data Center (102) is connected to the Internet (101). Also connected to the Internet (101) are a plurality of SPAM filters in various configurations (103). SPAM Filters and their configurations 103 are discussed in greater detail below.

The Data Center (102) is one or more generalized or specialized computers that includes CPU and Memory (32) and operating system (31). In addition, the Data Center (102) includes the following components: a White List (21), Black List (22), Unconfirmed List (23), Confirmation Message Records (20), Sender—Recipient Associations Database (24), Manual List Editing UI (25), Check Sender Status Service (27), Update Status Service (28), Sender Response Process (29), Crypto Engine (26) and List of SPAM Filter Public Keys (30) White List (21) is a list of confirmed message (e.g., email) senders, those who have successfully responded to a confirmation message (e.g., email) sent by the Data Center (102) or are otherwise confirmed (e.g., confirmed by other Data Centers or Spam Filters). By way of example, the Data Center will be described in terms of an email system. Those of ordinary skill in the art will recognize that the principles disclosed have applicability to other systems (non-email), including hybrid systems that only use email to receive or otherwise communicate with a sender or recipient but not both.

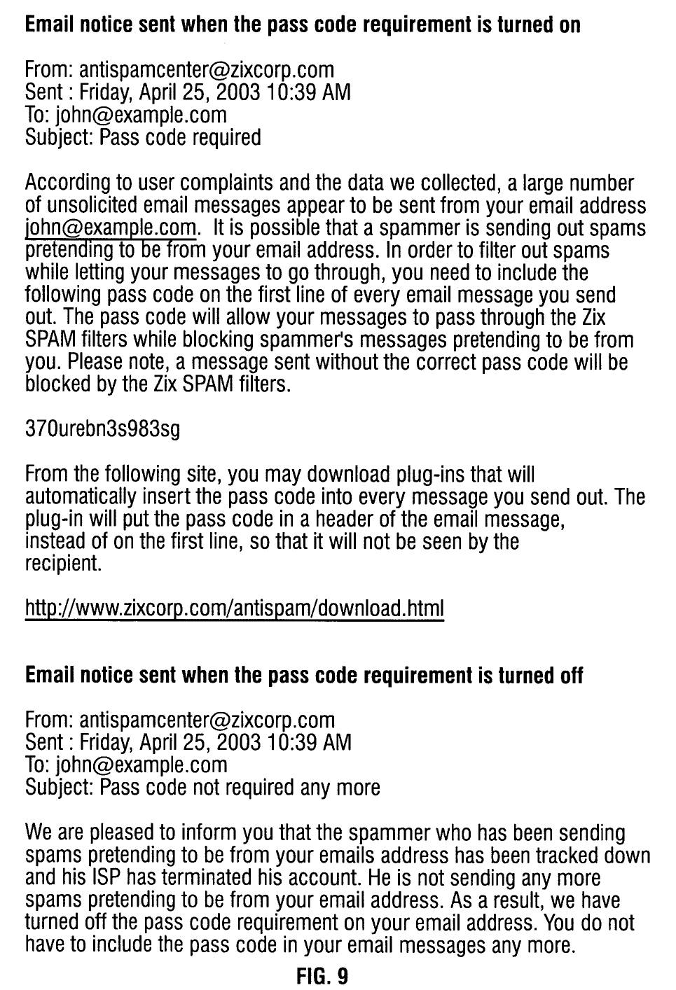

White list (21) can include individual email addresses as well as domain names to indicate that all email addresses in a given domain have been confirmed. Individual email addresses can be entered automatically when the sender successfully responds to the confirmation email or manually by the Data Center Operator using the Manual List Editing UI (25). Domain names can be entered into the white list manually. Thereafter, emails from confirmed senders identified in the White list (21) will generally be accepted by any one of the plurality of SPAM filters in the network and delivered to the recipients. One exception is when an email address in the white list is marked as “pass code required”. In this case, a message will be blocked unless it contains the correct pass code. When an email address is marked as “pass code required”, the associated pass code can also be stored along with the email address in White list (21). The Data Center Operator can enable or disable the pass code requirement manually using the Manual List Editing UI (25). The pass code requirement is enabled when the Data Center Operator discovers that a spammer is sending spams pretending to be a legitimate user in White list (21). The pass code can be disabled when the spammer has been tracked down and terminated. In one implementation, when the pass code requirement is enabled or disabled, an appropriate notice (e.g., email) will be sent to the affected sender (e.g., the email address that has been compromised). Thereafter, the sender can include the pass code in each transmission as appropriate. Examples of such email notices are shown in FIG. 9. Descriptions of pass codes and methods for verifying pass codes using the Data Center (102) and Spam Filters are discussed in greater detail below.

Black List (22) is a list of known Spammers or other type of malicious senders (e.g., email senders). Messages (e.g., emails) from these senders will generally be disposed by a receiving SPAM filter and will not be delivered to the recipients. Black list (22) can also include domain names to indicate that all email addresses in a given domain are in the Black list (22). Domain names and individual email addresses can be entered by the Data Center Operator using the Manual List Editing UI (25).

Unconfirmed List (23) contains the senders who have not responded to the confirmation messages (e.g., emails) yet. For each of the unconfirmed senders, additional data can be kept, including the time the first confirmation message (e.g., email) was sent (which can be used to calculate the maximum time the Data Center (102) has been waiting for the response to the confirmation message (time T)), and the number of confirmation messages sent to that sender (number N). In one implementation, both the number N and time T will be returned to a requesting SPAM Filter when the SPAM Filter queries the status of an unconfirmed sender.

Confirmation Message Records (20) stores relevant information for the confirmation messages (e.g., emails) sent to the Sender. In one implementation, each record contains the Sender email address, the Subject and Time of the original message (the original message from the Sender that caused the confirmation email to be sent), and the Authorization Code sent in the confirmation email. In one implementation, the record is identified by a unique “Confirmation Email ID”, which will also be sent in the confirmation email.

Sender—Recipient Associations Database (24) is used to store information of sender-recipient correlations. In one implementation, Sender—Recipient Associations Database (24) keeps a list of recipients a sender has ever sent a message to, the time the recipient was added to the list, and the number of repeated sends to a same recipient. From such information, the Data Center (102) can determine how many recipients a sender has been sending messages to, how fast his recipient list is growing, and whether he is sending to the same set of recipients repeatedly or sending to a large number of recipients without repeating. These characteristics can be used to distinguish spammers from legitimate bulk mail senders such as mailing lists. For a conventional mailing list sender, the recipient list will grow slowly while the number of repeated sends is relatively high. For a conventional spammer, the recipient list will grow very fast and repeated sends seldom occur, or at least, not until the recipient list has become very large.

Manual List Editing UI (25) is a program that has a user interface that allows a Data Center Operator to manually edit the White List (21), the Black List (22), the Unconfirmed List (23), and the Sender—Recipient Association Database (24).

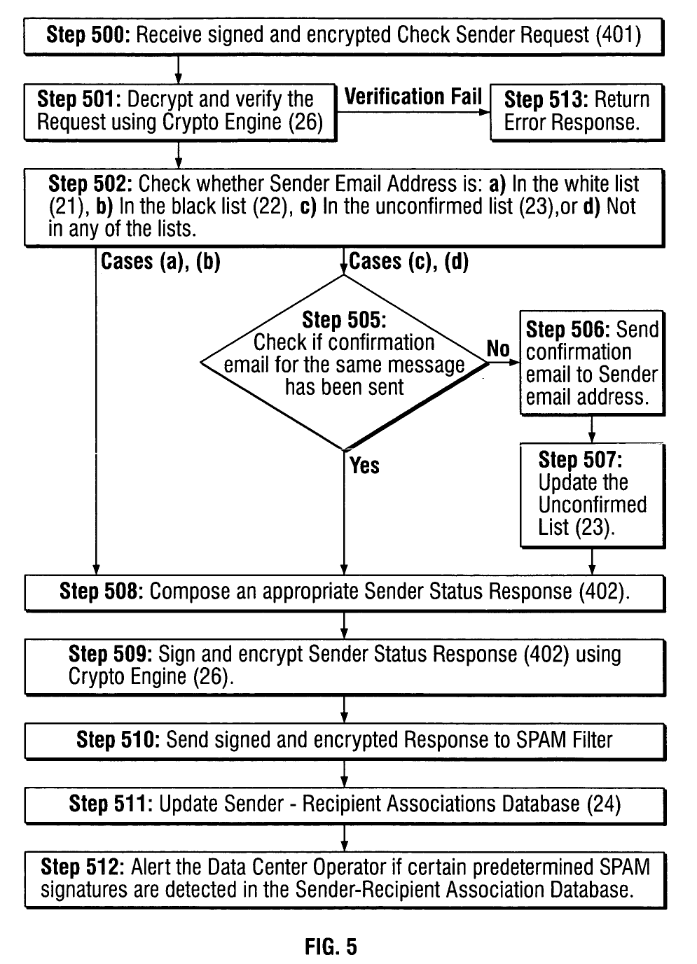

Check Sender Status Service (27) is a server program running on the Data Center (102) to process a Check Sender Request (401 in FIG. 4) from the SPAM Filter and return a Sender Status Response (402 in FIG. 4). This Request/Response pair allows a given SPAM Filter to retrieve the sender's status from the Data Center (102) (whether the sender is in White List (21), Black List (22), or Unconfirmed List (23)). In one implementation, the Check Sender Request contains both the sender's email address and associated recipients' email addresses, and therefore, can also be used to update the Sender—Recipient Association Database (24). FIG. 5 describes the logical flow of the Check Sender Status Service (27) in greater detail.

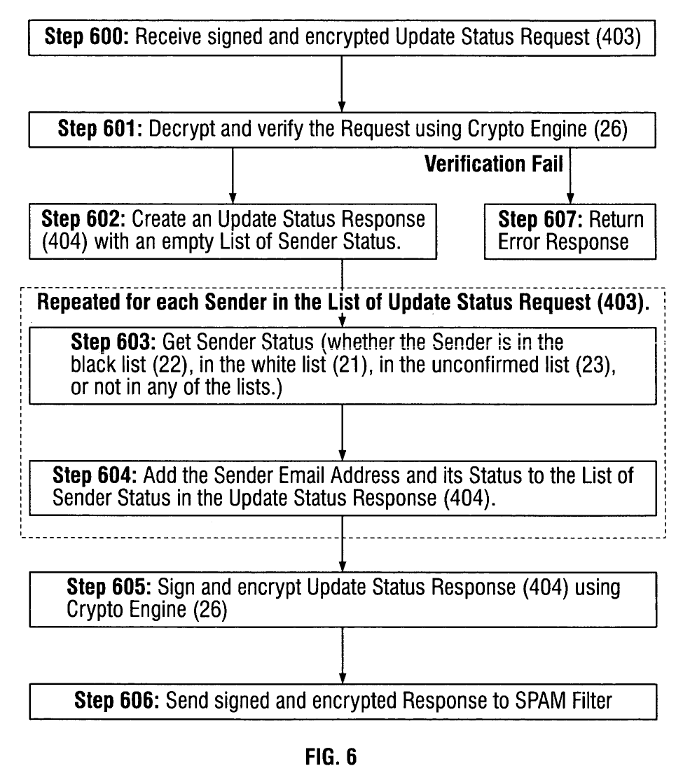

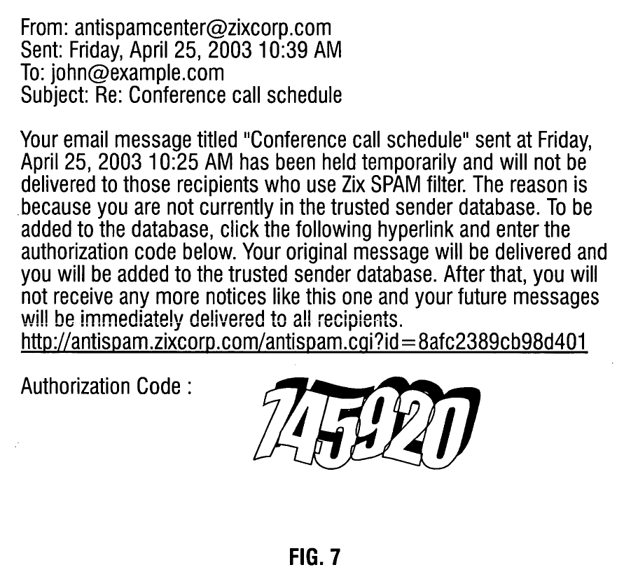

Update Status Service (28) is a server program running on the Data Center (102) to process an Update Status Request (403 in FIG. 4) from a given SPAM Filter and return an Update Status Response (404 in FIG. 4). This Request/Response pair allows the SPAM Filter to periodically check if the sender's status has changed in the Data Center (102) in order to decide whether a message held in temporary storage (e.g., Temporary Storage (36)) should be delivered, disposed, or continued to be held. FIG. 6 describes the logical flow of the Update Status Service (28) in greater detail.

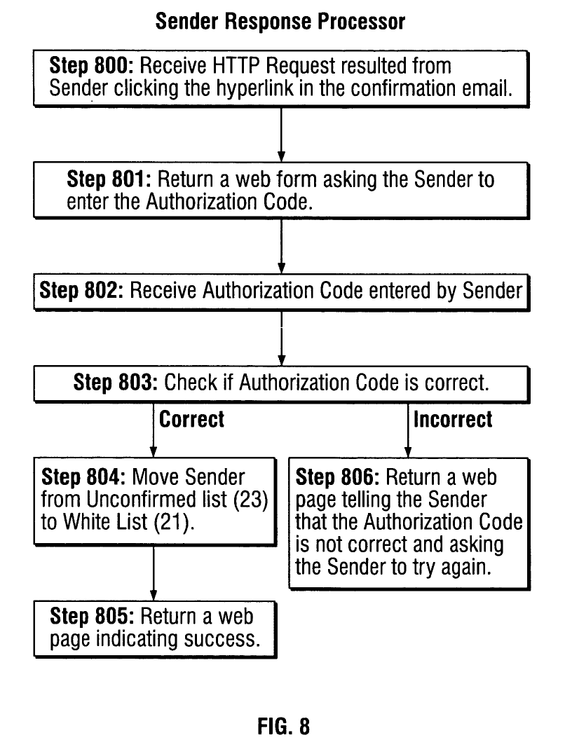

Sender Response Process (29) is a server program running on the Data Center to process the sender's response to the confirmation message (e.g., email). If the sender has responded to the confirmation message (e.g., email) correctly, his/her identifying information (e.g., email address) will be added to White List (21). FIG. 8 describes the logical flow of Sender Response Process (29) in greater detail.

Crypto Engine (26) is a set of cryptographic routines and related public/private keys To add to the security of the system, Crypto Engine (26) can be used to secure the communication between the Data Center (102) and the SPAM Filters In one implementation, the Check Sender Request (401 in FIG. 4), the Sender Status Response (402 in FIG. 4), the Update Status Request (403 in FIG. 4), and the Update Status Response (404 in FIG. 4) are all signed and encrypted messages. Crypto Engine (26) can be used by the Data Center (102) to decrypt a request from the SPAM Filter, verify the SPAM Filter's digital signature on the request, digitally sign the response, and encrypt the response. As would be apparent to one of ordinary skill in the art, encryption and digital signature are not absolutely necessary for the proposed spam system to work. However, they can be used for the following reasons. First, spammers like to sniff on the Internet to discover email addresses. A well-designed anti-SPAM system should not give spammers an advantage by sending email addresses over the Internet in the clear. For this reason, the communications between the SPAM Filter and the Data Center (102) can be encrypted. Second, the Data Center contains rich information about a large number of email addresses. Ideally not just anyone (i.e., a spammer) can send a request to the Data Center (102) to obtain such information (e.g., to harvest good email addresses). For this reason, the request sent to the Data Center (102) can be signed and only the digital signatures of legitimate SPAM Filters are honored by the Data Center (102).

List of SPAM Filter Public Keys (30) keeps a list of public keys of authorized SPAM Filters. As described above, only digital signatures that can be verified by a public key in the list are considered legitimate in one implementation.

FIG. 1 also shows three different configurations 103 in which the SPAM Filter is used. A SPAM Filter for Mail Server configuration provides a SPAM Filter (103a) between the Firewall (7) and the Mail Server (9) of a typical corporate network. In such a configuration, the SPAM filtering is carried out before emails reach the Mail Server (9). In this configuration, the SPAM Filter (103a) can be a software layer running on the same computer of the Mail Server (9), or on a dedicated computer between the Firewall (7) and the Mail Server (9).

A SPAM Filter for Email Client configuration provides a SPAM filter (103b) that is typically a software layer running on the same computer of the Email Client (10), for example, a “plug-in” of the Microsoft Outlook. In such a configuration, SPAM filtering is carried out before the email message is put into the Inbox of the email client. Such a client-based configuration can be used by individual email users connected to the Internet through an ISP or by email users of a corporation that would rather conduct SPAM filtering at the email client level, instead of at the gateway. In such a system, the SPAM Filtering is conducted when the email messages are retrieved from the ISP or Mail Server (11).

In a third configuration, a SPAM Filter (103c) is used as one of the services in a third party hosted secure email solution (106). Third party hosted secure email solutions redirect all email messages of a corporation to a third party system via a Virtual Private Network (VPN) or other type of secure connection, where the email messages can be virus scanned, SPAM-filtered, encrypted, decrypted, digitally signed, and verified, according to configurable policies. As shown in FIG. 1, an Email Message Redirector (8), sitting between the Firewall (7) and the Mail Server (9), redirects all incoming and outgoing email messages to the third party system (106) via a VPN. The third party system can provide all the services to secure the email messages, including the service provided by SPAM Filter (103c) and other services (12). If the third party system (106) is located in the same secure environment of the Data Center (102) (Operated by the same entity), SPAM Filter (103c) can directly access the Data Center (102) without using the Internet (101), as shown in FIG. 1. In such a case, encryption and digital signature for the communication between the SPAM Filter and the Data Center will be optional.

SPAM Filters (103a-c) can be identically configured and include the following components: SPAM Filter Logic (33), Temporary Message Storage (36), Held Message Handler (35) and Crypto Engine (34)

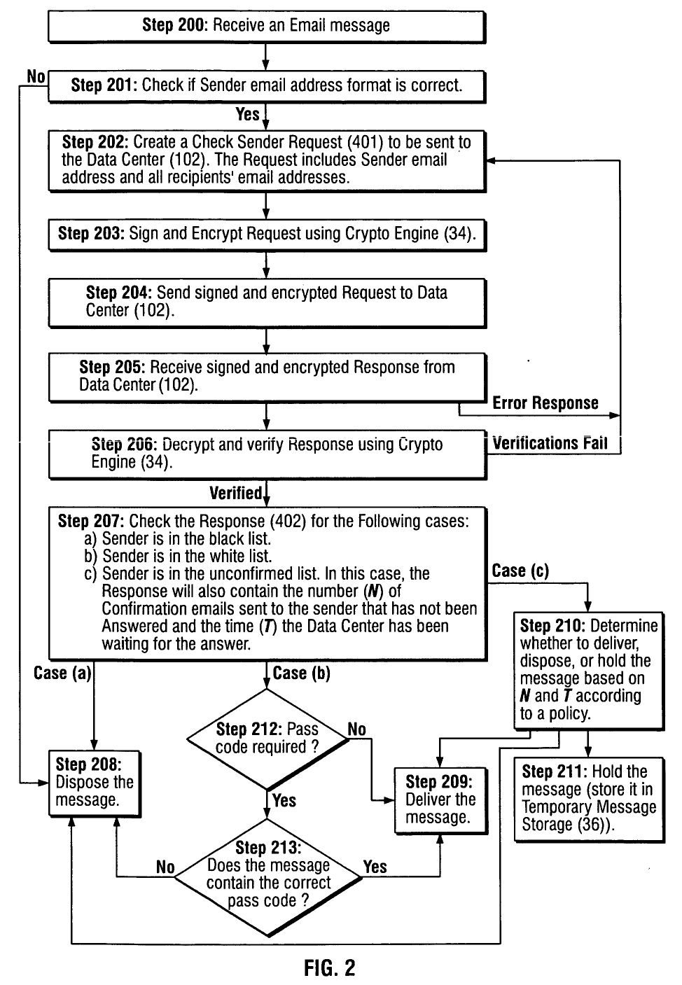

SPAM Filter Logic (33) is a process that conducts SPAM filtering. When a message (e.g., email message) is received at the SPAM Filter, the SPAM Filter Logic (33) will query the Data Center (102) for the status of the sender, and then decide whether the message should be delivered, disposed, or temporarily held in the Temporary Message Storage (36). The logical flow of the process is described in more detail in FIG. 2.

Temporary Message Storage (36) is used to temporarily hold the messages from the senders in the Unconfirmed List (23)—those senders that the Data Center (102) is still waiting for their responses to the confirmation messages (e.g., email confirmation messages).

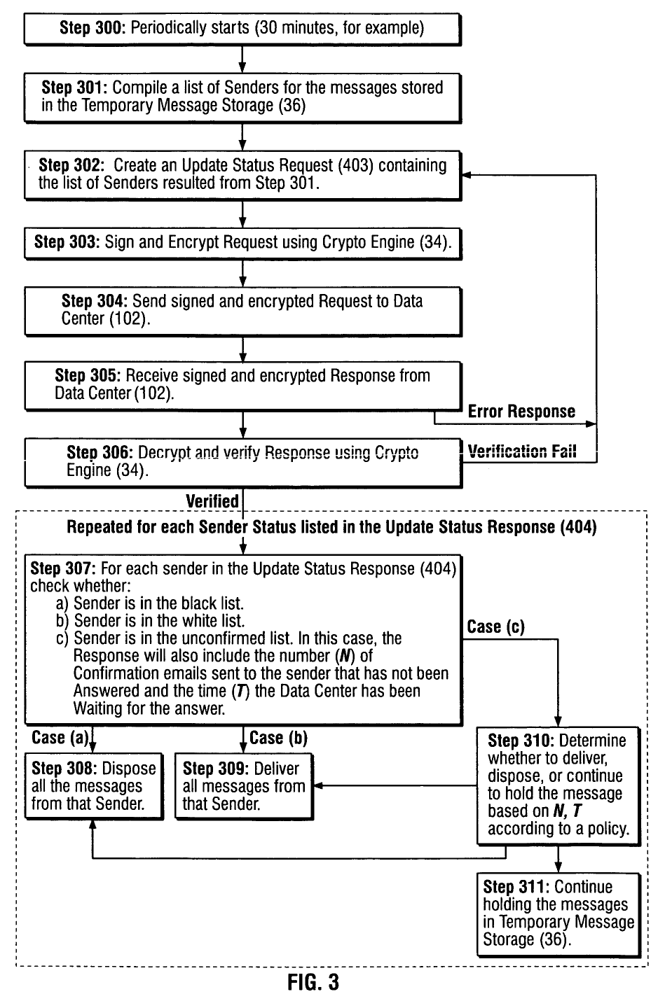

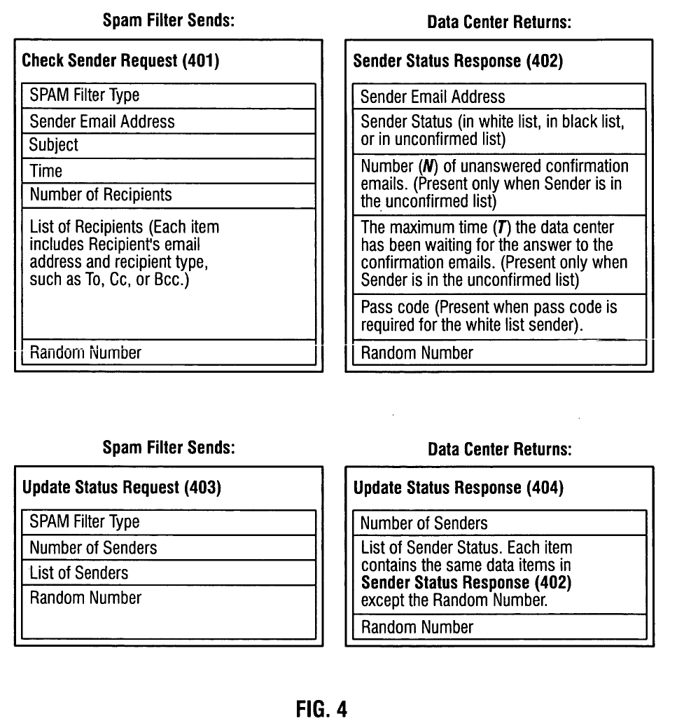

Held Message Handler (35) is a process for handling the messages temporarily held in the Temporary Message Storage (36). In one implementation, Held Message Handler (35) process will automatically start at fixed intervals, check the sender status at the Data Center (102), and then decide whether the messages held in the Temporary Message Storage (36) should be delivered, disposed, or continue to be held. The logical flow of the Held Message Handler (35) process is described in more detail in FIG. 3.

Crypto Engine (34) is a set of cryptographic routines and related public/private keys that can be used to secure the communications between the Data Center (102) and the SPAM Filters. Crypto Engine (34) can be used by the SPAM Filter to sign and encrypt the requests sent to the Data Center (102) and decrypt and verify the responses from the Data Center (102). In one implementation where the SPAM Filter (103c) for third party hosted solution is located in the same secure environment of the Data Center (102), the SPAM Filer (103c) can directly access the Data Center (102) and the Crypto Engine (34) is not necessary.

Referring now to FIG. 2, the detailed logical flow of SPAM Filter Logic (33) is shown. The process starts at Step (200) when a message (e.g., email message) is received. By way of example, the process will be described in terms of an email system.

At Step (201), SPAM Filter Logic (33) checks if the email message contains properly formatted information. For example, the SPAM Filter Logic (33) can at this step check the sender email address in the “From:” field. In one implementation, if the message contains a “Reply-to:” field, the format of the “Reply-to:” address will also be checked. The general format of all Internet headers and the consistency between them can also be checked. A domain name lookup can be conducted at this step to check if the domain of sender's email address actually exists and the IP address is consistent with the IP address making the SMTP connection, if such information is available. If any of the proscribed checks fails, the process will jump to Step (208) to dispose the message and the process ends. If all the checks succeed, the process continues to Step (202).

At Step (202), SPAM Filter Logic (33) creates a “Check Sender Request” to be sent to the Data Center (102). In one implementation, the data items included in the Check Sender Request is shown in FIG. 4 as item (401). Check Sender Request (401) can include a SPAM Filter Type (which indicates whether the SPAM Filter is mail server based (103a), client based (103b), or third party hosted (103c)), Sender Email Address, Subject, Time, a list of Recipients, and a Random Number. The Sender Email Address can be either the “Reply-to:” address, if the message has one, or the “From:” address, if the message does not have a “Reply-to:” header. The subject can be the subject of the email message. The Time can be the time of the message converted to a universal time that does not depend on time zone. The list of Recipients can include the number of recipients, and then for each recipient, the recipient's email address and the recipient type (such as To, Cc, or Bcc). Subject and Time can be used in the confirmation email to give the sender a reference to the original message. Subject and Time can also be used to uniquely identify the message, so that the Data Center (102) will not send out duplicated confirmation messages (e.g., emails) when a message sent to multiple recipients reaches different SPAM Filters. The Recipient list is used to send the Sender—Recipient correlation information to the Data Center (102). Sender—Recipient Correlation information can be used to distinguish spammers from other legitimate bulk mailers, such as a subscription-based mailing list. The Random Number in the Request can be returned in the Response from the Data Center (102). The Random Number can be used to ensure that the Response received from the Data Center (102) is truly generated by the Data Center in real time, not a “playback” event.

At Step (203), SPAM Filter Logic (33) signs and encrypts the Check Sender Request (401) using the Crypto Engine (34). As was described above, this step is optional. In one implementation, a 1024-bit RSA algorithm is used for both the public key encryption and digital signature, a 160-bit SHA1 is used for the secure hash, and a 128-bit AES algorithm is used for symmetric key encryption. More specifically, the SPAM Filter uses its 1024-bit RSA private key to sign the SHA1 hash computed from the Check Sender Request (401) to create the signature. The signature is then attached to the Request to create the signed Request. Finally, the signed Request is encrypted by a randomly generated 128b-bit AES symmetric key, which in turn, is encrypted by the 1024-bit RSA public key of the Data Center (102).

At Step (204), SPAM Filter Logic (33) sends the (optionally signed and encrypted) Check Sender Request (401) to the Data Center (102). In one implementation, an HTTP POST is used to send the signed and encrypted Request to the Data Center (102). The HTTP protocol typically has little or no problems penetrating conventional corporate firewalls. For a third party hosted SPAM Filter (103c) that accesses the Data Center (102) directly, Step (204) may send a plaintext Check Sender Request (401) without digital signature and encryption.

At Step (205), SPAM Filter Logic (33) receives the (optionally signed and encrypted) Response from the Data Center (102). If an error response is received from the Data Center (as a result of a communication error) or the Request is otherwise corrupted or tampered with (e.g., the signature can not be verified), the process may continue at Step (202) to try again.

At Step (206), SPAM Filter Logic (33) (decrypts as necessary and) verifies the Response received from the Data Center (102) (again, using the Crypto Engine (34) as required). In one implementation, a 1024-bit RSA algorithm is used for both the public key encryption and digital signature, a 160-bit SHA1 is used for the secure hash, and a 128-bit AES algorithm is used for symmetric key encryption. More specifically, the SPAM Filter uses its 1024-bit RSA private key to recover a 128-bit AES key encrypted by the SPAM Filter's public key. Then, the AES key is used to decrypt the Response. The SPAM Filter then verifies the digital signature on decrypted Response. Specifically, the signature is verified using the public key of the Data Center (102) to recover a SHA1 hash. Then, the recovered hash is compared with the hash computed from the Response to see if they are equal. In addition, the process also compares the Sender Email Address and the Random Number in the Response to see if they are the same as those sent in the request (this ensures that the Response is truly generated by the Data Center in response to the Request, and is not a “playback” event). If any of the decryption and signature verification steps fails, indicating that the Response may be corrupted or tampered with, the process returns to Step (202) to try again. If all the decryption and verification succeed, the process will continue to Step (207). Again, Step (206) may not be necessary for a third party hosted SPAM Filter (105) situated in the same secure environment of the Data Center (102).

At Step (207), SPAM Filter Logic (33) interprets the Response received from the Data Center (102). The Response can be of the form of a “Sender Status Response” shown as item (402) of FIG. 4. In the implementation shown, the Sender Status Response (402) contains Sender Email Address and Sender Status indicating whether the Sender is in the White List (21), in the Black List (22), or in the Unconfirmed List (23). If the Sender is in the Unconfirmed List (23), two additional data items, the Number N and the Time T, can also included in the Sender Status Response (402). Number N refers to the number of unanswered confirmation messages (e.g., emails) that have been sent to that Sender. Time T, refers to the maximum time the Data Center (102) has been waiting for the response to the confirmation messages (e.g., emails) from the Sender. A Pass Code may be included in the Sender Status Response (402) when the Sender is in the White list (21). The receipt of a Pass Code indicates that the SPAM Filter should block the message, unless it contains the correct Pass Code. If the Sender is in the Black List (22) (Case a), the process continues at Step (208). If the Sender is in the White List (21) (Case b), the process continues at Step (209). If the Sender is in the Unconfirmed List (23) (Case c), the process continues at Step (210).

At Step (212), SPAM Filter Logic (33) checks if a Pass Code is in the Sender Status Response (402). If so, it indicates that the correct Pass Code is required for the message to be delivered and the process continues at Step (213) to check the Pass Code in the message. Otherwise, the process continues at Step (209) to deliver the message.

At Step (213), SPAM Filter Logic (33) checks if the message contains the correct Pass Code. If so, the process continues at Step (209) to deliver the message. Otherwise, the process continues at Step (208) to dispose the message.

At Step (210), SPAM Filter Logic (33) uses the Number N and Time T to determine whether to dispose the message, deliver the message, or hold the message in the Temporary Message Storage (36) according to a local policy. One example policy is: If N<3 and T<24 hours, deliver the message; if N>10 or T>120 hours, dispose the message; otherwise, hold the message in the Temporary Message Storage (36). This example policy will allow 1 or 2 messages to go through immediately before an unconfirmed Sender has a chance to respond to the confirmation email within 24 hours. However, if the Sender has not responded to more than 10 confirmation emails or has not responded to the first confirmation email within 5 days, he will be treated as a spammer and all future messages from this sender will be disposed using a local policy allows each SPAM Filter to set an individual criterion for determining what should be treated as a SPAM and how tight the SPAM filtering should be (whether to allow a few messages to be delivered before the sender's email address is confirmed). If at Step (210), SPAM Filter Logic (33) determines that the message should be disposed, the process continues at Step (208). If at Step (210), SPAM Filter Logic (33) determines that the message should be delivered, the process continues at Step (209). If at Step (210), SPAM Filter Logic (33) determines that the message should be held in the Temporary Message Storage (36), the process continues at Step (211).

At Step (208), SPAM Filter Logic (33) will dispose the message, and after that, the process ends. The disposition of the message may include sending the message to a junk mail box, putting the message into a “SPAM folder”, writing the message into a log file, or simply deleting the message. The messages reaching Step (208) are regarded as SPAM messages and should ordinarily be deleted. Sending notifications to the sender, recipient, or administrator will only amplify the SPAM problem.

At Step (209), SPAM Filter Logic (33) will deliver the message to the recipient(s), and thereafter, the process ends.

At Step (211), SPAM Filter Logic (33) will store the message in the Temporary Message Storage (36), and thereafter, the process ends. In one implementation, messages stored in the Temporary Message Storage (36) are indexed by the senders' email addresses so that a list of senders can be easily obtained and all messages from a particular sender can be easily manipulated.

Messages held in the Temporary Message Storage (36) are processed by the Held Message Handler (35). In one implementation, Held Message Handler (35) automatically starts at a fixed interval (e.g., 30 minutes) to check with Data Center (102) to determine if the status of the senders of the messages held in the Temporary Message Storage (36) has been changed and then decide whether a message should be delivered, continued to be held, or disposed. The logical flow of the Held Message Handler (35) is shown in FIG. 3.

The process of Held Message Handler (35) starts at Step (300) at fixed intervals, for example, 30 minutes. At Step (301) Held Message Handler (35)compiles a list of senders' emails addresses from the messages stored in the Temporary Message Storage (36). In one implementation where the messages stored in the Temporary Message Storage (36) are indexed by senders' email addresses as described in Step (211), the list of senders can be easily obtained.

At Step (302), Held Message Handler (35) creates an “Update Status Request”. In one implementation, the data items included in the Update Status Request is as shown in FIG. 4 including item (403). Update Status Request (403) contains a SPAM Filter Type, a List of Sender Email Addresses, and a Random Number. The SPAM Filter Type indicates whether the SPAM Filter is mail server based (103a), client based (103b), or third party hosted (103c). The List of Sender Email Addresses can include all senders whose messages are held in the Temporary Message Storage (36). The Random Number in the Request will be returned in the Response from the Data Center (102). The Random Number is used to ensure that the Response received from the Data Center is truly generated by the Data Center in real time, not a “playback” event.

At Step (303), Held Message Handler (35) signs and encrypts the Update Status Request (403) using the Crypto Engine (34). In one implementation, 1024-bit RSA algorithm, 160-bit SHA1, and 128-bit AES are used to sign and encrypt the Update Status Request (403) in the same way as described in Step (203). As described above, the signing and encryption of the Update Status request is optional.

At Step (304), Held Message Handler (35) sends the (optionally signed and encrypted) Update Status Request (403) to the Data Center (102). For a third party hosted SPAM Filter (105) that accesses the Data Center (102) directly, Held Message Handler (35) may send the Update Status Request (403) without digital signature and encryption. In response to the transmission, Held Message Handler (35) may receive an error response from the Data Center (102) if there is any communication error or the Request is corrupted or tampered with. In this case, the process will continue at Step (302) to try again.

At Step (305), Held Message Handler (35) receives the (optionally signed and encrypted) Response from the Data Center (102). For a third party hosted SPAM Filter (105) situated in the same secure environment of the Data Center (102), the Response received may not be signed and encrypted.

At Step (306) Held Message Handler (35) decrypts and verifies the Response received from the Data Center (102) using the Crypto Engine (34) as required. Similar to Step (206), the verifications can not only include verifying the digital signature on the Response, but also include verifying that the List of Senders and the Random Number in the Response are the same as those sent in the Request. This ensures that the Response is truly generated by the Data Center in response to the Request, not a “playback” event. If any of the decryption and verification steps fails, indicating that the Response may be corrupted or tampered with, the process continues at Step (302) to try again. If all the decryption and verification checks succeed, the process will continue to Step (307).

In one implementation, the Response from the Data Center (102), after decryption and signature verification, is an “Update Status Response” as is shown as item (404) in FIG. 4. The Update Status Response (404) contains a List of Sender Status and a Random Number. The Random Number is the same Random Number sent in the Request and has been used in Step (306) to thwart the “playback” attack. The List of Sender Status can be a list where each item contains the same data items of a Sender Status Response (402) except the Random Number. In other words, each item in the List of Sender Status can contain the Sender Email Address and a Sender Status indicating whether the Sender is in the White List (21), Black List (22), or Unconfirmed List (23), and if the Sender is in the Unconfirmed List (23), the number of unanswered confirmation emails (N) and the maximum time (T) the Data Center (102) has been waiting for the answer to confirmation emails will also be included in the item.

The remainder of the logical flow starting from Step (307) will be repeated for each Sender in the List of Sender Status in the Update Status Response (404). The processing for each Sender is very similar to the Steps (207)-(211) in FIG. 2. However, after processing each item in the List of Sender Status, the process will continue at Step (307) so as to process the next item in the List, until all the Senders in the List have been processed.

At Step (307), Held Message Handler (35) decides what to do next according to the status of the Sender. If the Sender is in the Black List (22) (Case a), the process continues at Step (308). If the Sender is in the White List (21) (Case b), the process continues at Step (309). If the Sender is in the Unconfirmed List (23) (Case c), the process continues at Step (310).

Similar to Step (210) in FIG. 2, at Step (310) Held Message Handler (35) uses the Number N and Time T to determine whether the Sender's messages held in the Temporary Message Storage (36) should be delivered, continued to be held, or otherwise disposed according to a local policy. In one implementation, the same policy used in Step (210) of FIG. 2 is used in Step (310) for consistency. If at Step (310) Held Message Handler (35) determines that the message should be otherwise disposed, the process continues at Step (308). If at Step (310) Held Message Handler (35) determines that the message should be delivered, the process continues at Step (309). If at Step (310) Held Message Handler (35) determines that the message should continued to be held in the Temporary Message Storage (36), the process continues at Step (311).

At Step (308), Held Message Handler (35) will dispose all messages in the Temporary Message Storage (36) that are from the particular Sender, and thereafter, the process continues at Step (307) again to process the next item in the List of Sender Status. The disposition of the messages may include sending the messages to a junk mail box, putting the messages into a “SPAM folder”, writing the messages into a log file, or simply deleting the messages. At Step (309), Held Message Handler (35) will deliver to the recipient(s) ALL messages in the Temporary Message Storage (36) that are from the particular Sender, and thereafter, the process continues at Step (307) again to process the next item in the List of Sender Status.

At Step (311), Held Message Handler (35) will maintain ALL the messages from the particular Sender in the Temporary Message Storage (36). The process then continues at Step (307) to again process the next item in the List of Sender Status. After finishing processing ALL the items in the List of Sender Status at Step (308), (309), or (311), the process ends.

Referring now to FIG. 5, the logical flow of the Check Sender Status Service (27) in the Data Center (102) is shown. The function of the Check Sender Status Service (27) is to receive the (optionally signed and encrypted) Check Sender Request (401) sent from the SPAM Filter at Step (204) of FIG. 2, and then return a (optionally signed and encrypted) Sender Status Response (402) that will be received by the SPAM Filter at Step (205) of FIG. 2.

The process of Check Sender Status Service (27) starts at Step (500) when the (optionally signed and encrypted) Check Sender Request (401) sent from the SPAM filter at Step (204) is received. At Step (501), Check Sender Status Service (27) decrypts and verifies the signed and encrypted Request using the Crypto Engine (26) to recover the Check Sender Request (401) as necessary. The verification can not only verify the digital signature on the Request using the public key of the SPAM Filter, but can also verify that the SPAM Filter's public key is in the List of SPAM Filer Public Keys (30) to ensure that the key is authentic. The Check Sender Request (401) may not be signed and encrypted at all, when it is sent from a third party hosted SPAM Filter (105) situated in the same secure environment of the Data Center (102). In such a case, Step (501) can be skipped. If the decryption or verification fails at Step (501), the process continues at Step (513), which returns an error response to the SPAM Filter, and the process ends. If all the decryption and verifications succeed, the process continues to Step (502).

At Step (502), Check Sender Status Service (27) checks the status of Sender Email Address. There are 4 possibilities: a) the Sender is in the White List (21), b) the Sender is in the Black List (22), c) the Sender is in the Unconfirmed List (23), and d) the Sender is not in any of the lists. For cases a) and b)—the Sender is either in the White List (21) or is in the Black List (22), the process continues at Step (508). For cases c) and d)—the Sender is either in the Unconfirmed List (23) or not in any list at all, the process continues at Step (505).

At Step (505), Check Sender Status Service (27) checks whether a confirmation message (e.g., email) for the same message (e.g., as identified by subject and time) has been sent to the Sender Location (e.g., Email) Address previously. This step checks if a record can be found in the Confirmation Message Records (20) that contains the identifying information (e.g., Email Address, Subject, and Time) matching these items in the Check Sender Request (401). If so, the process continues at Step (508). Otherwise, the process continues at Step (506). Using the uniqueness of the identifying information (e.g., the Sender Email Address, Subject, and Time), the Data Center (102) can avoid sending multiple confirmation messages when a message addressed to multiple recipients is processed by several SPAM Filters. In other words, when an unconfirmed sender sends out one message to many recipients, he/she will only receive one confirmation message, regardless how many recipients are in the “To:”, “Cc:”, and “Bcc:” fields. However, the unconfirmed sender will continue receiving one confirmation message for each distinct message he sends out, regardless the number of recipients in the message header, until he answers one of the confirmation messages. Thereafter, the Sender will be included in the White List (21) and will not receive any further confirmation messages. The advantage of such a design is that it gives the Sender ample chances to answer one of the confirmation messages, even if the first a few confirmation messages are lost, ignored, or accidentally deleted. Such a design also avoids the annoyance of receiving too many confirmation messages. While the Subject and Time, which are also needed in the confirmation message to refer to the original message (see Step (506) below), are used to uniquely identify the message here, alternative ways of uniquely identifying the message are possible. For example, the Message-ID can be used to uniquely identify the message.

At Step (506), Check Sender Status Service (27) sends a confirmation message (e.g., email) to Sender (e.g., using the Sender Email Address). A Confirmation Message Record will also be created in the Confirmation Message Records (20). The Record is identified by a unique Confirmation Identifier (ID) and, in one implementation, includes the Sender Email Address, Subject, and Time obtained from the Check Sender Request (401), and a randomly generated Authorization Code. A typical example of a confirmation email is shown in FIG. 7. While the text of the confirmation message is arbitrary as long as it explains the purpose of the message and what to do with it, a few design considerations should be noted.

The confirmation message can include a hyperlink that includes the unique Confirmation Email ID (id=8afc2389cb98d401 in the example). This ID will be sent to Data Center (102) when the hyperlink is clicked allowing the Data Center (102) to quickly find the corresponding record in the Confirmation Message Records (20).

The subject of the confirmation message can be “Re: “plus the original subject (Subject in Check Sender Request (401)). This gives the original message sender an indication that the confirmation message is in response to his original message. Otherwise, the confirmation message itself can be easily mistaken as a SPAM and ignored, because it is from a location (e.g., email address (antispamcenter@zixcorp.com in the example)) unknown to the original message sender. The subject and the time (Subject and Time in Check Sender Request (401)) are used to refer to the original message. In one implementation, there is no mentioning of the recipients. This avoids exposing the recipients' email addresses in the confirmation message, which is sent in the clear (not encrypted). As mentioned before, a well-designed system should avoid unnecessary exposure of user email addresses.

The Authorization Code can be randomly generated, converted to a distorted graphic form, such as a GIF, and then attached to the confirmation message. This makes it very difficult for a machine to recognize the authorization code. It requires a human to answer the confirmation email correctly.

One noteworthy example situation relates to the processing of the confirmation messages by the SPAM Filters, if for example the Sender has a SPAM Filter installed. In order to avoid unnecessary delays, the sender address of the confirmation message (antispamcenter@zixcorp.com in the example of FIG. 7), can be included in White List (21) before Data Center (102) starts to operate. This will cause all SPAM Filters to allow the confirmation messages to pass through the system immediately. The sender address of the confirmation message (e.g. antispamcenter@zixcorp.com) can require a pass code, because the address will become common knowledge. Accordingly to avoid spammers from spoofing the system, the Pass Code can be used and verified by all SPAM Filters. The Pass Code can be included in a user header in the confirmation message and the same Pass Code can be returned in the Sender Status Response (402) when the SPAM Filter queries the status of the sender address (e.g., antispamcenter@zixcorp.com). Because the Data Center (102) controls both the Pass Code in the confirmation message and the Pass Code in the Sender Status Response (402), the Pass Code for the Sender Location (e.g., antispamcenter@zixcorp.com) can be changed frequently to avoid being discovered and used by spammers.

In an alternative implementation, the domains or email addresses protected by a SPAM Filter can be manually entered into the white list when a customer purchases the SPAM Filter. In this way, the confirmation messages will never be sent to an email address protected by a SPAM Filter (because the email address protected by the SPAM Filter has already been added to the white list when the customer purchased the SPAM Filter). In such an alternative implementation, if the sender email address of the confirmation message (e.g., antispamcenter@zixcorp.com) is used only for sending confirmation emails and not for other purposes (e.g. contacting customers), then it can be included in Black list (22) to block messages that appear to be originating from it. In this case, the email notices, such as those shown in FIG. 9 should use a sender email address that is different from the sender email address of the confirmation email to avoid being blocked.

After sending the confirmation message at Step (506), the process continues at Step (507) to update the Unconfirmed List (23). In one implementation, each item in the Unconfirmed List (23) contains the Sender data (e.g., Sender Email Address), the time the first confirmation message was sent (which can be used to calculate the maximum time (T) the Data Center (102) has been waiting for the answer to the confirmation messages), and the number of confirmation messages sent (N). The procedure of updating the Unconfirmed List (23) depends on whether the Sender is already in the List (depends on whether it is case c), or case d described above)). If the Sender is already in the Unconfirmed List (23) (case c)), the process will simply increase the number of confirmation emails sent (N) by 1. On the other hand, if the Sender is not in the Unconfirmed List (23) (case d)), the process will add a new item to the Unconfirmed List (23). The item added to the Unconfirmed List (23) can include the Sender Email Address, the time of the first confirmation email (the time of the confirmation email sent at Step (506) (which can be used to calculate (T) later), and the number of confirmation emails sent N=1. After Step (507), the process for cases c) and d) also continues at Step (508).

At Step (508) Check Sender Status Service (27) composes an appropriate Sender Status Response (402). In one implementation, the data items included in the Sender Status Response is shown in item (402) of FIG. 4. In this example, the Response includes the Sender Email Address and the Sender Status indicating whether the Sender is in the White List (21), in the Black List (22), or in the Unconfirmed List (23). If the Sender is in the White List (21) and is marked as “pass code required”, the associated Pass Code will also be include in the Sender Status Response (402). If the Sender is in the Unconfirmed List (23), the number of confirmation emails sent (N), and the maximum time the Data Center is waiting for the answer to the confirmation emails (T) can also be included in the Sender Status Response (402). T can be calculated as the current time minus the time the first confirmation email was sent to the Sender. The Sender Status Response (402) also can include a Random Number, which is copied from the Random Number in the Check Sender Request (401).

At Step (509), Check Sender Status Service (27) optionally signs and encrypts the Sender Status Response (402) using the Crypto Engine (26). For a third party hosted SPAM Filter (103c) situated in the same secure environment of the Data Center (102), Step (509) is not necessary and may be skipped.

At Step (510), Check Sender Status Service (27) sends the (optionally signed and encrypted) Sender Status Response (402) to the requesting SPAM Filter.

At Step (511), Check Sender Status Service (27) uses the Sender identification information (e.g., Sender Email Address) and the List of Recipients in the Check Sender Request (401) to update the Sender—Recipient Associations Database (24). In one implementation, the Sender-Recipients Associations Database (24) keeps a list of recipients a sender has ever sent a message to, the time the recipient was added to the list, and the number of repeated sends to the same recipient. In addition, the Sender—Recipient Associations Database (24) will keep a list of Subject and Time of the recent messages sent by the sender (within one month, for example). In such an implementation, the Check Sender Status Service (27) first checks if the Subject and Time are already in the list of Subject and Time of the recent messages. If so, the process will do nothing, because the same message has already been processed. (A message sent to multiple recipients may be processed several times by different SPAM Filters.) Otherwise, the process will update the Sender—Recipient Associations Database as follows. In one implementation, the Subject and Time of the message will be added to the list of recent messages associated with the Sender in the Sender—Recipient Associations Database (24). In addition, the Check Sender Status Service (27) will process all recipients in the List of Recipients in the Check Sender Request (401) as follows. If the recipient is not in the recipient list of the Sender, the recipient will be added to the list, the time the recipient is added to the list will be recorded, and the number of repeated send operations will be set to zero (0). If the recipient is already in the recipient list of the Sender, the number of repeated sends for that recipient will be increased by one (1). After updating the Sender—Recipient Association Database (24) at Step (511), the process continues at Step (512).

At Step (512), the Check Sender Status Service (27) checks for a predefined trigger condition for detecting spammers are met, and if so, the Data Center Operator can be notified. The Operator can investigate the situation further and decide whether the Sender is a spammer. If so, the Sender can be moved to the Black List (22) manually using the Manual List Editing UI (25). One example of a trigger condition is that the number of recipients in the recipient list exceeds certain value, 10,000, for example. Another example of a trigger condition is a sudden increase in the number of recipients in the recipient list in a short period of time. It should be noted, when a commercial system built according to this invention is first rolled out, the Sender-Recipient Associations Database may not be very useful, because there are very few SPAM Filters installed at the beginning, and the information collected by the SPAM Filters represents only a tiny fraction of the total Sender—Recipient correlation information available. At this stage, however, because the number of messages processed by the system is small, the trigger condition can be set relatively loose and the trigger event rate will not be too high for the Data Center Operator to investigate. When the commercial system is in place for some time (many SPAM Filters will be installed in various places), the Sender—Recipient correlation information collected will become more reliable to allow more sophisticated trigger conditions to be set to better identify spammers. In one implementation, identified spammers can be automatically moved to the Black List (22) without further investigation of the Data Center Operator. After Step (512), the process ends.

Because Steps (511) and (512) are carried out after the Data Center (102) has already returned the (optionally signed and encrypted) Sender Status Response (402) at Step (510), Steps (511) and (512) do not have to be run in the same process as the Check Sender Status Service (27). In one implementation, after Step (510), the process of Check Sender Status Service (27) may simply spawn a separate process to run Steps (511) and (512) in the background and then terminate. Such a design will give the Data Center (102) faster response to serve the Check Sender Requests. In one implementation, Step (512) is not connected to the Check Sender Request process. In this implementation, Step (512) can be run in a process that starts periodically, completely independent of the processing of Check Sender Requests, so as to analyze the Sender—Recipient Associations Database (24) to look for signatures of spammers.

Referring now to FIG. 6, the logical flow of Update Status Service (28) is shown. Update Status Service (28) allows the Data Center (102) to receive the Update Status Request (403) from the SPAM filter and returns an Update Status Response (404). In one implementation, Update Status Request (403) contains only the Senders whose messages are held in the Temporary Message Storage (36) of the SPAM Filter. The SPAM Filter considers those Senders as Unconfirmed. The Update Status Response (404) notifies the SPAM Filter which of those originally Unconfirmed Senders have been moved to the White List (21) or Black List (22), and for those that are still in the Unconfirmed List (23), how many confirmation messages have been sent to each of them and how long the Data Center has been waiting for an answer.

The process of Update Status Service (28) starts at Step (600) when the (optionally signed and encrypted) Update Status Request (403) is received. The Request (403) is sent at Step (304) of the Held Message Handler process (35) shown in FIG. 3.

At Step (601), Update Status Service (28) decrypts and verifies the Request using the Crypto Engine (26) to recover the Update Status Request (403) as required. The verification can verify the digital signature on the Request using the public key of the SPAM Filter, but also can verify that the SPAM Filter's public key is in the List of SPAM Filer Public Keys (30) to ensure that the key is authentic. As indicated above, the Update Status Request (403) may not be signed and encrypted and, in such a case, Step (601) can be skipped. If the decryption or verification fails at Step (601), the process continues at Step (607), which returns an error response, and the process ends. If all the decryption and verifications succeed, the process continues at Step (602).

At Step (602), Update Status Service (28) creates an Update Status Response (404) with an empty List of Sender Status. In one implementation, the Update Status Response (404) contains the Random Number copied from the Update Status Request (403) but has an empty List of Sender Status. The Sender Status will be added to the List by repeating Steps (603) and (604) for each Sender.

Step (603) and Step (604) are repeated for each Sender listed in the Update Status Request (403). At Step (603), Update Status Service (28) obtains the Sender Status and Step (604) adds the status information to the List of Sender Status of the Update Status Response (404). In one implementation, each item added to the List is identical to the Sender Status Response (402) except it does not contain the Random Number. In other words, each item added to the List of Sender Status contains the Sender Email Address and the Sender Status indicating whether the Sender is in the White List (21), Black List (22), or Unconfirmed List (23). If the Sender is in the Unconfirmed List (23), the number of unanswered confirmation emails (N) and the maximum time (T) the Data Center (102) has been waiting for the answer to the confirmation emails can also be included in the response. After finishing processing all Senders at Steps (603) and (604), the process continues at Step (605).

At Step (605), Update Status Service (28) optionally signs and encrypts the Update Status Response (404) using the Crypto Engine (26). For a third party hosted SPAM Filter (103c) situated in the same secure environment of the Data Center (102) and that has direct access to the Data Center (102), Step (605) is not necessary and may be skipped.

At Step (606), Update Status Service (28) sends the (optionally signed and encrypted) Update Status Response (404) to the requesting SPAM Filter. Thereafter, the process ends.

Referring now to FIG. 8, the logical flow of Sender Response Process (29) for the Data Center (102) to process Sender's responses to the confirmation messages is shown. In the implementation where the Sender responds to the confirmation message by clicking a provided hyperlink, a default web browser will be launched and an HTTP request will be sent to the Data Center (102).

The logical flow of Sender Response Process (29) starts at Step (800) when the HTTP request is received. The HTTP request can include the Confirmation Message ID (e.g., Confirmation Email ID), which can be used to locate the corresponding record in the Confirmation Message Records (20).

At Step (801), Sender Response Process (29) returns a response (e.g., an HTTP response), which includes an Authorization Code. In one implementation, the response includes a web (e.g., HTML) form asking the Sender to enter the Authorization Code included in the confirmation message. After the Sender enters the Authorization Code and clicks an “OK” button on the web form, the Authorization Code will be sent to the Data Center (102). Because the Authorization Code contained in the confirmation message is in a distorted graphic form in one implementation, human action is required to enter the code correctly.

At Step (802), Sender Response Process (29) receives the Authorization Code (e.g., sent in the web form).

At Step (803), Sender Response Process (29) checks if the Authorization Code is correct. In one implementation, the process will use the Confirmation Email ID included in the HTTP request to locate the corresponding record in the Confirmation Message Records (20). The process will compare the Authorization Code in the record with the Authorization Code received at Step (802) and see if they match. If they do NOT match, the process continues at Step (806), which, in one implementation, returns a web page telling the Sender that the Authorization Code is not correct and asks the Sender to try again. Thereafter the process ends. If the Authorization Code obtained from the record matches the Authorization Code received at Step (802), the process continues to Step (804)

At Step (804), Sender Response Process (29) moves the Sender from the Unconfirmed List (23) to the White List (21). In addition, all the records in the Confirmation Message Records (20) corresponding to confirmation messages sent to the same Sender will be deleted.

At Step (805), Sender Response Process (29) returns a response (e.g., a web page) indicating success. The web page can tell the Sender that he has been successfully added to the trusted sender database and will not receive any more confirmation emails. Thereafter, the process ends.

While this invention has been described in terms of several preferred implementations, it is contemplated that alterations, modifications and permutations thereof will become apparent to those skilled in the art upon a reading of the specification and study of the drawings.

For example, instead of having the SPAM Filter periodically query the Data Center (102) for sender's status, the Data Center (102) can automatically notify the SPAM Filter when a sender status changes. In addition, the SPAM filters can keep copies of the White, Black and unconfirmed lists, which may in turn be regularly updated by the Data Center (102) to improve processing speed at the local SPAM filter. When an unconfirmed sender has successfully answered a confirmation message and has been moved to the white list, the Data Center can send an email message that contains the changed sender status to all affected SPAM Filters.

Instead of keeping the List of SPAM Filter Public Keys (30) at the Data Center, each SPAM Filter may be issued a digital certificate that authenticates its public key. The digital certificate can be included in the Check Sender Request (401) and the Update Status Request (403) sent to the Data Center. The Data Center can then verify the digital certificate, instead of checking the List of SPAM Filter Public Keys (30), to ensure that the SPAM Filter's public key is authentic.

While the implementation disclosed above is designed under the principle of never unnecessarily transmitting users' email addresses in the clear, such a principle may be viewed as less important than simplicity of implementation. In this case, the encryption and digital signature do not have to be implemented.

While the above has described the Data Center (102) as a generalized or specialized computer, those skilled in the art will recognize that a cluster of many computers distributed over different parts of the Internet, coordinated to serve the same functionality as described above, can be used to provide redundancy, higher throughput and faster response time.

While the response to the confirmation message is described as clicking a hyperlink and entering the authorization code, those skilled in the art will recognize that many other types of responses are possible. For example, the sender may return an email message with the authorization code or call a telephone number to enter the authorization code.

While the implementation disclosed above uses the Data Center to send out confirmation emails and process the answers, a different design configuration is possible. For example, the confirmation emails and answers can be sent and processed by individual SPAM Filters and the result of the confirmation (success or failure) can be sent to the Data Center to update the white list kept there and shared among all SPAM Filters.

Some features of the disclosure will be used without corresponding use of other features. Furthermore, additional features may be employed without changing the operation of the present invention. Accordingly, it is appropriate that the appended claims be construed broadly and in a manner consistent with the disclosure.

1. A method for detecting spam in a messaging system comprising:
generating a white list of confirmed message senders, each of said confirmed message senders having been confirmed as being able to receive messages;
sharing the white list among a plurality of spam filters in the messaging system;
using the white list at a given one of the plurality of spam filters to determine if a sender of a received message has been previously confirmed, and if so, forwarding the received message to a recipient without separately confirming the sender.

2. The method of claim 1 wherein the messaging system is an email system

3. The method of claim 1 wherein the white list is shared with at least two spam filters.

4. The method of claim 1 wherein if the sender has not been previously confirmed, sending a confirmation to the sender, verifying a response from the sender, and if the response is verified, adding the sender to the white list at the given spam filter and sharing the information with other spam filters in the messaging system.

5. The method of claim 1 wherein sharing includes publishing the white list at a central location.

6. The method of claim 1 wherein using the white list includes checking the white list maintained at a central location.

7. The method of claim 1 wherein the if the sender has not been previously confirmed, the method further including sending a confirmation to sender, verifying a response from the sender, and if the response is verified, adding the sender to the white list at a central location that is shared among the plurality of spam filters.

8. A method for identifying a spam message comprising:
Receiving a message at a spam filter in a network that includes a plurality of spam filters;
Identifying the sender of the message;
Determining if the sender has been previously confirmed as a valid sender including determining if the sender is included in a list of confirmed senders for any spam filter in the network; and
If so, then forwarding the received message to a recipient without separately confirming the sender.

9. The method of claim 8 wherein the message is an email message.

10. The method of claim 8 wherein the white list is shared with at least two spam filters.

11. The method of claim 8 further comprising:
determining if the sender has not been previously confirmed and if not confirmed
sending a confirmation to the sender,
verifying a response from the sender, and
if the response is acceptable,
adding the sender to the white list at the given spam filter and
sharing information with other spam filters in network, the information including information indicating that the sender has been confirmed.

12. The method of claim 11 wherein sharing includes publishing the white list at a central location

13. The method of claim 11 wherein determining includes checking a white list maintained at a central location

14. The method of claim 13 further comprising
if the sender has not been previously confirmed,
sending a confirmation to the sender,
verifying a response, and
if the response is acceptable,
adding the sender to the white list shared among the plurality of spam filters.

15. A method for detecting a spammer in a network that includes a plurality of spam filters:
collecting information relating to a sender from a plurality of the spam filters:
determining a trend in the collected information; and
identify a spammer based on the trend.

16. The method of claim 15 wherein collecting information includes collecting information relating to a number of messages sent by a sender to unrelated email addresses.

17. The method of claim 15 wherein determining trends includes correlating the messages received by an individual spam filter relating to a same sender.

18. The method of claim 15 wherein identifying includes determining that a sender is a spammer if a number of messages sent to unrelated email addresses in the correlated data exceeds a predetermined threshold.

19. The method of claim 18 wherein the threshold is time dependent.

20. A method for detecting spam in a messaging system comprising:
generating a white list of confirmed message senders and maintaining the white list at a data center:
receiving a message at a spam filter in a network that includes a plurality of spam filters:
verifying with the data center that the sender of the message is a confirmed message sender, add if so, forwarding the received message to a recipient without separately confirming the sender.

21. The method of claim 20 wherein the message is an email message.

22. The method of claim 20 further comprising sharing the white list with at least two spam filters in the network.

23. The method of claim 20 further comprising determining if the sender has not been previously confirmed, and if not confirmed then
sending from the data center a confirmation to the sender,
verifying a response received at the data sender, and
if the response is acceptable,
adding to the white list a name identifying the sender and
sharing information identifying the sender as being confirmed with other spam filters in network

24. A method for identifying a spam message comprising:
Receiving a message at a spam filter in a network that includes a plurality of spam filters;
Identifying the sender of the message;
Verifying with a data center coupled to a plurality of the spam filters if the sender has been previously confirmed as a valid sender including determining if the sender is included in a list of confirmed senders for any spam filter in the network, said list maintained at the data center;
If the sender has been previously confirmed, forwarding the received message to a recipient without separately confirming the sender.

25. The method of claim 24 wherein the message is an email message.

26. The method of claim 24 wherein the list is shared with at least two spam filters.

27. The method of claim 24 further comprising determining if the sender has not been previously confirmed, and if not confirmed
sending from the data center a confirmation to the sender,
verifying if the response is acceptable, and
adding an name identifying the sender to the list maintained at the data center.

28. A method for detecting a spammer in a network that includes a plurality of spam filters:
collecting, using a data center, information relating to a sender from a plurality of the spam filters:
determining a trend in the collected information;
identify a spammer based on the trend, including adding the sender to a list of confirmed spammers maintained by the data center.

29. The method of claim 28 wherein collecting information includes collecting information relating to a number of messages sent by a sender to unrelated email addresses.

30. The method of claim 28 wherein determining trends includes correlating messages received by an individual spam filter relating to a same sender.

31. The method of claim 28 wherein identifying includes determining that a sender is a spammer if a number of messages sent to unrelated email addresses in the correlated data exceeds a predetermined threshold.

32. The method of claim 31 wherein the threshold is time dependent.

33. A method for filtering spam in a messaging system comprising:
confirming that a message sender can receive;
sharing information indicating that the message sender can receive among a plurality of spam filters in the messaging system;
using said information at a given one of the plurality of spam filters to determine if a message should be allowed without separately determining whether the message sender can receive.

34. The method of claim 33 wherein the message is an email message.

35. The method of claim 33 further comprising confirming at a first spam filter in the system that a sender of a message can receive messages.

36. The method of claim 35 further comprising receiving the message at a second spam filter.

37. The method of claim 35 further comprising sharing information developed by the first spam filter with one or more other spam filters in the messaging system.

38. The method of claim 37 further comprising sharing the information with a data center, and thereafter allowing access by each of the spam filters in the messaging system to the information.

39. The method of claim 33 wherein the information is maintained in a list of confirmed senders.

40. The method of claim 39 wherein the list is shared with a plurality of the spam filters in the messaging system.

41. The method of claim 39 wherein the information is maintained in a list which is maintained by a data center accessible by a plurality of spam filters in the messaging system.

42. The method of claim 41 further comprising sharing the list with a plurality of spam filters in the messaging system.

43. The method of claim 42 further comprising maintaining a copy of the list at a plurality of spam filters in the messaging system.

44. The method of claim 39 further comprising associating a passcode with one or more of the confirmed senders in the list, and verifying a message received from a sender in the list includes the passcode if specified.

45. The method of claim 44 further comprising triggering an addition of a passcode for a sender in the list upon an occurrence of an predefined event.

46. The method of claim 45 wherein the event includes detection that an email address associated with the sender has been compromised.

47. The method of claim 39 further comprising including a pass code in the list for each confirmed sender and verifying the pass code is included in the message prior to forwarding the message from the sender to a recipient.

48. The method of claim 47 further comprising automatically adding the passcode associated with the sender at a time for transmission of a message from the sender in the messaging system.

49. The method of claim 48 further comprising providing a plug in module for automatically adding the passcode, the plug in module adapted to add the passcode prior to transmission to the messaging system.

50. The method of claim 33 further comprising
correlating sender-recipient data at a spam filter in the messaging system and determining data related to how fast a list of recipients grows for a given sender;
determining a list of unacceptable senders using the sender-recipient data and the determined data; and
sharing the list of unacceptable senders with other spam filters in the messaging system.

51. The method of claim 50 further comprising maintaining a list of recipients for each sender of messages processed by a given spam filter.

52. The method of claim 51 further comprising maintaining the list of recipients for each sender at a data center.

53. A method for processing messages at a spam filter in a messaging system, the messaging system including a plurality of spam filters, the method comprising:
receiving a message for processing, the message from an sender for delivery to an intended recipient;
determining if the sender is a confirmed sender, including querying a data center to determine if the sender is included in a list of confirmed senders based on information received from any of the plurality of spam filters in the messaging system, where confirmed senders are senders having a verified capability to receive messages;
if the sender is a confirmed sender, enabling transmission of the message to the intended recipient.

54. A method for processing messages at a spam filter in a messaging system, the messaging system including a plurality of spam filters, the method comprising:
receiving a message for processing, the message from a sender for delivery to an intended recipient;
determining if the sender is a confirmed sender, including querying a data center to determine if the sender is included in a list of confirmed senders based on information received from any of the plurality of spam filters in the messaging system, where confirmed senders are senders having a verified capability to receive messages;
if the sender is a not a confirmed sender, confirming the sender including sending the sender a notification;
upon receipt of a confirmation from the sender, sharing the sender's confirmed status with the plurality of spam filters in the messaging system including publishing the sender's status to the data center.

55. A method for minimizing spam in a messaging system, the messaging system including a plurality of spam filters, the method comprising:
receiving a request from one of the spam filters in the messaging system to verify if a sender of a message is a confirmed sender, a confirmed sender being a sender having a verified capability to receive messages;
evaluating a list of confirmed senders;
providing a notification to the one spam filter indicating whether the sender's status is confirmed.

56. A method for minimizing spam in a messaging system, the messaging system including a plurality of spam filters, the method comprising:
receiving a request from one of the spam filters in the messaging system to verify if a sender of a message is a confirmed sender, a confirmed sender being a sender having a verified capability to receive messages;
evaluating a list of confirmed senders;
if the sender is not included in the list of confirmed senders,
confirming the sender including providing a notification to the sender and upon receipt of a confirmation from the sender, sharing the sender's status with the other spam filters in the messaging system including adding the sender to the list; and
providing a notification to the one spam filter indicating whether the sender's status is confirmed.

57. The method of claim 56 wherein the step of confirming the sender is performed by a spam filter.

58. The method of claim 56 wherein the step of confirming the sender is performed by the requesting spam filter.
